(19) United States
(12) Patent Application Publication
(10) Pub. No.: US 2012/0278197 A1
(43) Pub. Date: Nov. 1, 2012

(54) METHOD FOR SALE OF GOODS AND SERVICES OVER A NETWORK

(76) Inventor: Thomas Nguyen, San Diego, CA (US)

(21) Appl. No.: 13/542,589

(22) Filed: Jul. 5, 2012

Related U.S. Application Data
(63) Continuation of application No. 12/890,500, filed on Sep. 24, 2010.

(51) Int. Cl. G06Q 30/08

(52) U.S. Cl. 705/26.3

(57) ABSTRACT

Among other things, techniques, systems, apparatus, methods and computer readable storage medium with executable instructions for carrying out online auctions are described. Features of the invention pertain to facilitating the sale of goods and services through an auction, offering bidders the potential for purchasing goods and services at huge discounts from retail pricing, providing bidders compelling reasons for purchasing goods by enabling winning bidders to optionally make a potential profit on goods or services they have purchased at substantial savings by re-auctioning the items, and providing losing bidders with the potential to become qualified to participate in prospective profits from subsequent auctions for products similar to the items they did not win.

### CROSS REFERENCE TO RELATED APPLICATION

This application is related by common inventorship to, is a continuation-in-part of and claims priority to pending U.S. application Ser. No. 12/890,500 of Sep. 24, 2010 by Thomas Nguyen, entitled “Method for Sale of Goods and Services Over a Wide Area Network”, the contents of which are hereby incorporated by reference herein in their entirety for all purposes.

### FIELD OF THE INVENTION

Disclosed herein are systems and methods relating to sales of goods and services employing a wide area network. More particularly, the systems and methods disclosed relate to online auctions for bidders wishing to purchase offered products.

### BACKGROUND OF THE INVENTION

With the advent of the Internet, online sales of goods and services have become common place. In recent years, online auction sites have become a fixture of electronic commerce. For instance, sites such as eBAY provide buyers with an immense selection of goods and services to bid upon. Many auctions provide buyers with the potential of finding specialized goods and services at bargain prices. Because prices are not fixed, online buyers may purchase items at significant discounts to retail list prices. Auctions also provide sellers a benefit, in that the goods are sold with no fixed price and the competition among buyers or bidders can significantly increase the sales price.

More recently, however, participants in conventional online auctions began identifying certain difficulties demonstrating areas for improvement. One problem is “sniping” which occurs when bidders wait until literally the last few seconds of an auction to bid, thereby snatching the auction win from a previous legitimate bidder, often by only a very small margin. This type of behavior may upset conventional bidders because an unscrupulous bidder is able to usurp a winning bid without fear of being subsequently outbid. Moreover, this practice results in distorted prices paid to a seller because bidders, legitimate and otherwise, tend to wait to place their bids until right before the auction timer's expiration—contrasted with a conventional auction which continues until no more bids are placed. Unfortunately, online auctions that are open to bidding by potentially millions of customers are not conducive to such real-time bidding and cessation methods.

An additional problem that occurs is conventional auction sites such as eBAY fail to excite the buyers in a fashion akin to live auctions, where bidders get caught up in the moment and increase prices. Instead, the duration of the auction time is fixed and bidders may return at any time before the cessation time to bid. Many bidders fail to return and, as noted above, other bidders simply wait until the last moment or employ a computer service to input a last minute bid, thereby lowering the potential selling price for the seller.

As such, there is an unmet need for an online auctioning method and system which will service to put the excitement back into the bidding process. Such a method should endeavor to eliminate the fixed time for bidding cessation which is such a problem with conventional auction sites and thereby impart a sense of urgency in bidders to immediately place bids. Such a site should also instill excitement in bidders by offering products and providing bidders the potential to purchase such products at huge discounts within the uncertain time frame of a conventional auction. Still further, such a method and system should provide winning bidders with the potential to reap profits from their participation by allowing them to participate as sellers in subsequent auctions. Finally, such an auction site should also instill some excitement in losing bidders by providing a means to qualify the losing bidder to also potentially profit by participating in profits from subsequent auctions for the products which they did not initially win.

### SUMMARY OF THE INVENTION

Some embodiments of the present invention that are shown in the drawings are summarized below. These and other embodiments are more-fully described in the Detailed Description section. It is to be understood, however, that there is no intention to limit the invention to the forms described in the Summary of the Invention or in the Detailed Description. One of skill in the art can recognize that there are numerous modifications, equivalents and alternative constructions that fall within the spirit and scope of the invention as express in the claims.

In accordance with the present invention, a computer-implemented method, a system and a computer program product comprising a computer usable medium having a computer readable program code embodied therein that is adapted to be executed to implement a method for carrying out an online auction are described.

One aspect of the invention relates to methods, systems (e.g., systems comprising a processor that is operable to carrying out methods) and computer program products for auctioning one or more items to one or more bidders. The methods, systems and computer program products may be configured to: store, for two or more bidders, a number of available bids associated with each of the two or more bidders; provide, during a first adjustable time period, a first current bid value associated with a first item; during the first adjustable time period, receive a first plurality of successive bids from a first plurality of bidders; for each of the first plurality of successive bids, increment the first current bid value of the first item by a predetermined amount; and/or determine whether each respective bidder from the first plurality of bidders is a qualified bidder.

The methods, systems and computer program products may be further or alternatively configured to: during the first adjustable time period, determine a respective aggregate number of bids from the first plurality of successive bids attributable to each of the first plurality of bidders; based on the respective aggregate number of bids for each of the first plurality of bidders, determine whether each of the respective bidders is the qualified bidder; determine that a first bidder of the first plurality of bidders is a qualified bidder when the first current bid value is greater than a cost of the first item; and/or send, for display at a remote computing device operated by each qualified bidder, an indication that the respective qualified bidder is qualified at the time the indication was sent.

The methods, systems and computer program products may be further or alternatively configured to: determine that the first bidder of the first plurality of bidders is a qualified bidder when a first aggregate number of bids for the first bidder is greater than a predetermined percentage of the cost of the first item, or a first aggregate number of bids for the first bidder is greater than a difference between the first current bid value and the cost of the first item; and/or

The methods, systems and computer program products may be further or alternatively configured to: determine that the first bidder of the first plurality of bidders is a qualified bidder when a first aggregate number of bids for the first bidder is greater than a predetermined percentage of the first current bid value.

The methods, systems and computer program products may be further or alternatively configured to: determine that the first bidder of the first plurality of bidders is a qualified bidder when a first aggregate number of bids for the first bidder is greater than each of the first aggregate number of bids for each remaining bidder of the first plurality of bidders.

The methods, systems and computer program products may be further or alternatively configured to: during the first adjustable time period, determine a respective aggregate number of bids from the first plurality of successive bids attributable to each of the first plurality of bidders; based on the respective aggregate number of bids for each of the first plurality of bidders, determine whether each of the respective bidders is the qualified bidder; determine that a first bidder of the first plurality of bidders is a qualified bidder when a first total number of bids for the first bidder associated with the first item and one or more other items is greater than a predetermined percentage of a sum of the first current bid value of the first item and respective bid values of the one or more other items; and send, for display at a remote computing device operated by each qualified bidder, an indication that the respective qualified bidder is qualified at the time the indication was sent.

The methods, systems and computer program products may be further or alternatively configured to: during the first adjustable time period, determine a respective aggregate number of bids from the first plurality of successive bids attributable to each of the first plurality of bidders; based on the respective aggregate number of bids for each of the first plurality of bidders, determine whether each of the respective bidders is the qualified bidder; determine that a first bidder of the first plurality of bidders is a qualified bidder when a first total number of bids for the first bidder associated with the first item and one or more other auction items is greater than a first threshold number of bids; and send, for display at a remote computing device operated by each qualified bidder, an indication that the respective qualified bidder is qualified at the time the indication was sent.

The methods, systems and computer program products may be further or alternatively configured to: upon cessation of the first adjustable time period, identify a first winning bidder associated with a last bid of the first plurality of successive bids and identify the first current bid value; receive, from the first winning bidder, a request to re-auction the first item; provide, during a second adjustable time period, a second current bid value associated with the first item; during the second adjustable time period, receive a second plurality of successive bids from a second plurality of bidders; for each of the second plurality of successive bids, increment the second current bid value of the first item by a predetermined amount; upon cessation of the second adjustable time period, identify a second winning bidder associated with a last bid of the second plurality of successive bids; provide a fractional portion of the second current bid value to the first winning bidder when the second current bid value exceeds a predetermined current bid value. The predetermined current bid value may equal the difference between the cost of the first item and the first current bid value.

The methods, systems and computer program products may be further or alternatively configured to: upon cessation of the first adjustable time period, determine a second aggregate number of bids from the first plurality of successive bids attributable to a first qualified bidder; receive, from the first qualified bidder, a request to auction a second item that is substantially similar to the first item; receive, from the first qualified bidder, a payment equal to the difference between a cost or suggested list price of the second item and the second aggregate number of bids from the first plurality of successive bids; provide, during a third adjustable time period, a third current bid value associated with the second item; during the third adjustable time period, receive a third plurality of successive bids from a third plurality of bidders; for each of the third plurality of successive bids, increment the third current bid value of the first item by a predetermined amount; upon cessation of the third adjustable time period, identify a third winning bidder associated with a last bid of the third plurality of successive bids; determine whether the third current bid value is greater than the cost of the second item; upon determining that the third current bid value is greater than the cost of the second item, provide a fractional portion of the third current bid value to the first qualified bidder; and upon determining that the third current bid value is less than the cost of the second item, refund the payment to the first qualified bidder.

The methods, systems and computer program products may be further or alternatively configured to: upon determining that the third current bid value is greater than the cost of the second item, determine whether the difference between the third current bid value and the cost of the second item is greater than the first aggregate number of bids for the first bidder; and upon determining that the difference between the third current bid value and the cost of the second item is greater than the first aggregate number of bids for the first bidder, refund the first aggregate number of bids to the first qualified bidder.

The methods, systems and computer program products may be further or alternatively configured to: receive, from the second winning bidder, a request to re-auction the first item; provide, during a fourth adjustable time period, a fourth current bid value associated with the first item; during the fourth adjustable time period, receive a fourth plurality of successive bids from a fourth plurality of bidders; for each of the fourth plurality of successive bids, increment the fourth current bid value of the first item by a predetermined amount; upon cessation of the fourth adjustable time period, identify a third winning bidder associated with a last bid of the fourth plurality of successive bids; and provide a fractional portion of the fourth current bid value to the first winning bidder and the second winning bidder when the fourth current bid value exceeds a the cost of the first item.

### BRIEF DESCRIPTION OF THE DRAWINGS

The present application may be more fully appreciated in connection with the following detailed description taken in conjunction with the accompanying drawings.

FIG. 1 shows a block diagram depicting a networked auction system for providing items for auction in accordance with at least one embodiment of the invention.

FIG. 2 illustrates a process flow diagram detailing a process for receiving user bids and determining whether any bidder is qualified to receive certain benefits.

FIGS. 3A-C illustrate various user interfaces.

### DETAILED DESCRIPTION OF THE INVENTION

Overview

Aspects and features of the current invention are designed to facilitate providing consumers a networked auction service that is adapted to restoring excitement to the bidding process and encouraging further participation by a user. In particular, this invention implements certain features to promote elevated bidding activity by providing qualified bidders opportunities to receive certain benefits apart from merely winning the item at auction.

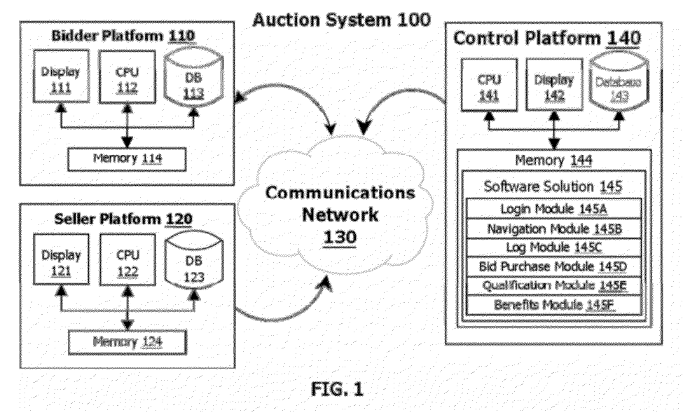

Referring now to the drawings, FIG. 1 generally shows an overview of a system for providing an auction service to consumers in accordance with at least one embodiment of the invention. A control platform 140 may communicate with a bidder platform 110 and a seller platform 120 over a communications network 130. These communications may include retrieving and displaying information pertaining to bidders of auctions and the items offered in those auctions. Accordingly, a user may bid on items offered for auction within an infrastructure able to facilitate a fast paced and dynamic bidding environment. Moreover, a user may participate in auctions to other users to further benefit from the excitement and urgency amongst participating bidders, thereby providing a fun and sometimes profitable experience for various users.

Bidder Platform 110

Generally, the bidder platform 110 may be any suitable computing device that facilitates communication with the other platforms and allows a user to submit bids on a particular item. Using the bidder platform 110, a user may search for auctioned items, input bids on items, and receive signals that inform the user of appropriate auction related information such as current bid amount, minimum bid increment, item descriptions, etc. Furthermore, the bidder platform 110 may provide a user with an indication (e.g., visual display, audio sound) of user related information such as remaining bid increments, total bid counts, qualification requirements, bid history, user profile information, and the like. For example, the bidder platform 110 may facilitate the display of a web-based graphic user interface for navigating the auction system and continually reporting appropriate information to a potential bidder participant.

Accordingly, the bidder platform 110 may be utilized by a user (e.g., a bidder) in relation to certain embodiments of invention, and may include any suitable computing device or combination of computing devices. Multiple bidder platforms 110 may be used by multiple users over a suitable network medium (e.g., Internet, Intranet, LAN). Furthermore, the bidder platform 110 may be any of numerous general purpose or special purpose computing system environments or configurations. Examples of well-known computing devices, systems, environments, and/or configurations that may be suitable for use with the implementations include, but are not limited to, personal computers, server computers, hand-held or laptop devices, multiprocessor systems, microprocessor-based systems, programmable consumer electronics, networked PCs, minicomputers, mainframe computers, and distributed computing environments that include any of the above systems or devices, and the like. Accordingly, one or more aspects taught herein may be incorporated into a phone (e.g., a cellular phone or smart phone), a computer (e.g., a laptop or mini laptop), a portable communication device (e.g., “tablet” computing devices), a kiosk device, or any other suitable device that is configured to communicate via a wireless or wired medium. One or more aspects taught herein may also be incorporated into user input devices (e.g., keyboard, mouse, touch screen, speech recognition) or output devices (e.g., display, audio outputs) implemented to improve the bidder platform 110.

Furthermore, the bidder platform 110 may include various components, including a display 111, a processor 112, a database 113, and memory 114 from which software may be executed (e.g., in a web browser). One of skill in the art will appreciate that the bidder platform 110 may include addition components not shown, and/or may include only a subset of the components shown in FIG. 1. These various components may help facilitate communications between a bidder and the rest of the system 100 while additionally generating interactive visual interfaces utilized by users participating in an auction.

Seller Platform 120

Generally, the seller platform 120 may be any suitable computing device that provides communication with the other platforms and allows a user to create an auction for a particular item. Using the seller platform 120, a user (e.g., a seller, a previous bidder) may submit information regarding an item the user wishes to auction on the system 100. Similar to the bidder platform 110, the seller platform 120 facilitates interaction between a seller and the rest of the system 100. The seller platform 120 may provide a user with dialogs for creating an auction listing for their auction item. In particular, the seller platform 120 may facilitate user input of seller information like item description, reserve price, shipping criteria, etc. Furthermore, the seller platform 120 may provide a user with an indication (e.g., visual display, audio sound) of auction related information such as bid history, current auction price, new bids received, item information, and the like. For example, the seller platform 120 may facilitate the display of a web-based graphic user interface for navigating the auction system and continually reporting appropriate information to a potential seller participant.

Accordingly, the seller platform 120 may be utilized by a user in relation to certain embodiments of invention, and may include any suitable computing device or combination of computing devices. Multiple seller platforms 120 may be used by multiple users over a suitable network medium (e.g., Internet, Intranet, and LAN). In fact, both a bidder platform 110 and a seller platform 120 may be accessible on the same device by a user. For example, a user who is both a bidder and a seller may use the web-based graphic interface described to switch between a bidder platform 110 and a seller platform 120 seamlessly. Moreover, a particular embodiment may be designed wherein both the bidder 110 and seller platforms 120, wholly or in part, are simultaneously accessible by a user. The seller platform 120 may be any of numerous general purpose or special purpose computing system environments or configurations. Examples of well-known computing devices, systems, environments, and/or configurations that may be suitable for use with the implementations include, but are not limited to, personal computers, server computers, hand-held or laptop devices, multiprocessor systems, microprocessor-based systems, programmable consumer electronics, networked PCs, minicomputers, mainframe computers, and distributed computing environments that include any of the above systems or devices, and the like. Accordingly, one or more aspects taught herein may be incorporated into a phone (e.g., a cellular phone or smart phone), a computer (e.g., a laptop or mini laptop), a portable communication device (e.g., “tablet” computing devices), a kiosk device, or any other suitable device that is configured to communicate via a wireless or wired medium. One or more aspects taught herein may also be incorporated into user input devices (e.g., keyboard, mouse, touch screen, speech recognition) or output devices (e.g., display, audio outputs) implemented to improve the seller platform 120.

Furthermore, the seller platform 120 may include various components, including a display 121, a processor 122, a database 123, and memory 124 from which software may be executed (e.g., in a web browser). One of skill in the art will appreciate that the seller platform 120 may include addition components not shown, and/or may include only a subset of the components shown in FIG. 1. These various components may help facilitate communications between a seller and the rest of the system 100 while additionally providing user interactivity between bidders and sellers participating in an auction.

Communications Network 130

The communications network 130 may be any suitable type of network. The communications network 130 may be configured to provide communication links between the bidder platform 110, the seller platform 120, and a control platform 140. Examples of communications links include the Internet, private networks (e.g., virtual private networks or “VPN”s), local area networks (e.g., LAN, WiLAN, Wi-Fi, Bluetooth), cellular, satellite, other wireless communication pathways, and/or other wired communication pathways.

As those skilled in the art will appreciate, various intermediary network routing and other elements between the communications network 130 and the platforms depicted in FIG. 1 have been omitted for the sake of simplicity. Such intermediary elements may include, for example, the public switched telephone network (PSTN), gateways or other server devices, and other network infrastructure provided by Internet service providers (ISPs). Further, those skilled in the art will also appreciate the various security protocols which may be implemented to protect a user from unscrupulous individuals who may attempt to hijack network communications to gain a bidding advantage or to misappropriate a bidder's personal information (e.g., Secured HTTP, encryption).

Control Platform 140

Generally, the control platform 140 may perform the intense data analysis, processing, and centralized storage required of a fully featured embodiment of the auction system 100. However, one skilled in the art would appreciate that any portion of data analysis, processing and storage of information may be delegated, distributed, or otherwise reallocated to any of platforms 110-130. Nonetheless, in one embodiment the control platform 140 may generally act as a central data server adapted to identify and track each user, auction, and transaction along with their associated information. Additionally, the control platform 140 may cause a user interface to be generated and presented at the one more computing devices of the bidder platform 110 and the seller platform 120, within which users may navigate available auctions, view displayed information, and submit information (e.g., bids, etc.). The control platform 140 may also utilize any collected information to generate certain additional benefits to bidders and sellers. Likewise, the same information may be used to determine whether a particular bidder or seller qualifies for any additional benefit. Thus, in this particular embodiment, the control platform 140 manages and tracks pertinent information that is subsequently analyzed to formulate determinations of whether an auction participant is qualified and, if so, what benefit the qualified participant may receive.

The control platform 140 of FIG. 1 is shown to include a processor 141, a display 142, a database 143, memory 144, and a software solution 145 including modules 145A-F. The database 143 is described herein in several implementations as a hard disk drive for convenience, but this is not required, and one of ordinary skill in the art will recognize that other storage media may be utilized without departing from the scope of the invention. In addition, one of ordinary skill in the art will recognize that the database 143 which is depicted as a single storage device, may be realized by multiple (e.g., distributed) storage devices. The database 143 may store data in a fixed file format, such as XML, comma separated values, tab separated values, or fixed length fields.

The database 143 may receive, store and send, among other data, data related to one or more user accounts (i.e., an entity bidding, selling or otherwise using the auction system 100), one or more auction items (i.e., each individual auction item that users may bid on), and one or more transactions (e.g., single bid, auction win, bid purchase, item payment) along with any additional data appropriate to each.

In accordance with certain aspects of the invention the control platform 140 may be configured to receive data from, send data to, and otherwise interact with the other platforms 110-120, using the communications network 120, to receive, analyze and process information from a user. For example, the control platform 140 may be configured to interact with the bidder 110 and seller platforms 120 to carry out certain functionality described herein including functionality related to generating a graphic user interface, identifying, tracking, and updating information related to users and auctions, managing the purchase of bids, determining a bidder's qualification status, and providing benefits to those qualified users. Particularly, the control platform 140 may interact with the bidder platform 110 and the seller platform 120 to receive, analyze, process and/or store information input by a user.

Software Solution 145

As shown in FIG. 1, the control platform 140 may comprise a software solution 145 that includes a login module 145A, navigation module 145B, log module 145C, bid purchase module 145D, qualification module 145E, and a benefits module 145E, that are each implemented in software. The processor 141 may be coupled to various components, including the database 143, the display 142, and memory 144 (e.g., RAM, ROM). The processor 141 may be configured to execute instructions embodied in the software solution 145 stored on the memory 144. As described above, the database 143 may serve as a centralized data bank of data, including information regarding one or more users and one or more auctions. One of skill in the art will appreciate that the software solution 145 may be configured to operate on personal computers (e.g., handheld, notebook or desktop) (not shown), servers (e.g., a single server configuration or a multiple server configuration) (not shown), or any device capable of processing instructions embodied in executable code. Moreover, one of ordinary skill in the art will recognize that alternative embodiments, which implement one or more components of the invention in hardware as detailed below, are well within the scope of the invention.

In one preferred embodiment, the software solution 145 may run as a web-based application on a device at the bidder platform 110 and seller platform 120. The software solution 145 application may be compatible with any device that supports a standard web-browser, and preferably would exhibit the same appearance and functionality on each. For example, the software solution 145 may be executed by a web server (not shown) which communicates with the other platforms 110-130 to cause the display of a software-based interface on a laptop, phone, tablet, desktop or other suitable computing/processing device. A user at the bidder platform 110, for example, may interact with the software solution 145 via various features on the bidder platform 110, including a web-based graphic user interface (“GUI”), to remotely modify and/or access the auction system 100, and to interact with one or more various auctions. One skilled in the art will appreciate that many other various devices may be used to interact with the software solution 145 such as cell phones, smart phones, and any other device which supports a standard web browser. Alternatively, the software solution 145 and associated components (e.g., processor 141, display 142, database 143, and/or memory 144) may reside on the either the bidder platform 110 or the seller platform 120.

Attention is now drawn to modules 145A-E of the software solution 145. Modules 145A-F may operate in concert with each other to perform certain functions of the software solution 145. Software solution 145 may include a login module 145A, a navigation module 145B, a log module 145C, a bid purchase module 145D, a qualification module 145E, and a benefits module 145F. Each module 145A-F may be associated with one or more functions of the software solution 145 and a description of each is provided in terms of certain functionality below.

Login Module 145A

Login module 145A may be configured to carry out aspects associated with identifying users of the system and assigning each with different permissions accordingly. Identification may be achieved by providing users with unique username and password combinations. The username and password may be assigned to a user or the user may select his/her own username and/or password. The login module 145A may be further configured to collect certain user information, including payment information (e.g., credit card, PayPal or other online payment processing service, checking account, etc.), shipping address, and other personal information.

A user may only access further modules and components of the auction system 100 by correctly inputting the user's unique username and password using the bidder platform 110 and/or seller platform 120. When an acceptable username and password is entered, the software solution 145 proceeds to the navigation module 145B for bidding and selling items on the auction system 100, detailed below. However, if a user enters an unacceptable username and password, the login module 145A may display an error message and allow the user to retry inputting a valid username and password. After a selectable number of failed attempts, the login module 145A may lock the user's account and/or send a notification email to that user, an administrator, or another user indicating the failed attempts and a procedure for unlocking the account.

If a prospective bidder or seller has not registered, and therefore has not received any authentication identifiers, simple registration may be provided to quickly furnish the user with a personal account and profile. Once registered, a user may access the auction system 100 and begin to bid on auction or choose to create their own auctions for others.

Navigation Module 145B

Generally, the navigation module 145B may be configured to generate a graphic interface for presentation at the bidder platform 110 or seller platform 120 so that a user at that platform may navigate and interact with the auction system 100. In particular, a user may utilize the graphic interface to browse available auctions, receive appropriate information regarding each item, submit bids, and also complete administrative tasks such as managing the user's account and profile information. Moreover, the navigation platform 145B may enable a user to perform a search of available auction items (e.g., by inputting searches, browsing categories, etc.). Alternatively, an advanced search may be available to facilitate a search on multiple fields including, for example, geographic location and price range.

As previously described, the navigation module 145B may present a web-based graphic user interface. The interface may be designed to be straightforward and user friendly and may be customizable by the user. Likewise, the content initially generated upon accessing the user interface may be random or targeted to a particular purpose. For example, a typical homepage may present an authenticated user with featured auctions, such as hot selling items or auctions with high bidding activity. Furthermore, the auction listings may be categorized to assist a user in finding desired auctions. Auctions may be split into any number of categories. For example, a simple category system may classify the product type of an auction (e.g., Clothes, Furniture, Books, etc), while another may categorize auctions using dynamic criteria such as date, time of day, current trends, and even an authenticated user's bid and search history.

Once a single auction item is selected by a user, the navigation module 145B may generate a page to display appropriate information about that item to the user. Information displayed may include an item description, seller information, current bid value, bid history, and other associated information. From this page, a user may choose to bid on the product, or may continue searching for another item. Typically, a user may bid any value they want; however in certain embodiments the bidder may only increase the bid by a small increment of money (e.g., $0.01). For instance, a single bid may cost the user a certain amount (e.g., $0.50), but placing that purchased bid in relation to an item may only increase the current bid value bid by a penny. Therefore, the initial bidding on the item is fast paced and exciting because the price is initially low compared to the cost of the item and/or the value of its potential resale. Different bid increment values and costs may be set for different products, or may otherwise be determined by other criteria such as a bidder's membership level (e.g., bids purchased by member users may cost less than bids purchased by non-members user, among other variations).

In addition to information about the auction item, the navigation module 145B may also generate an indication of whether a bidder is qualified in a particular auction. The indication may be associated with a user's participation (i.e., number of bids) regarding a particular auction, or a user's historical participation. The indication may be text based or graphic and may appear in the user interface. The indication of qualification may be updated as often as needed to constantly inform the user of their current qualification status. Since, in some embodiments, qualification may depend on a user's participation (e.g., a number of bids made by the user in relation to numbers of bids made by other users, a total cost of the bids made by the user in relation to a cost of an auction item, and/or a total cost of all bids in relation to the cost of the auction item, among other considerations), the status may need to be refreshed at least every time a bid is submitted. Thus, all bidders are encouraged to bid continuously to maintain their status as qualified for benefits should they happen to lose the auction on which they are bidding and are reminded constantly of their qualification status. One of skill in the art will appreciate that qualification status may permit users to enjoy certain benefits that non-qualified users may not enjoy. Hence, qualification status is an important feature of the present invention.

In another embodiment, the navigation module 145B may cause the display of a countdown timer indicating when the current auction will end. In particular, each item in the system 100 may have associated with it a preset amount of time within which users may bid on the item auctioned. The time period may either be set automatically by the auction site or chosen by the seller. The countdown timer may be visible on each auction's individual page or may be present when multiple items are displayed to the user (e.g., within a page of search results). The timer gives the user an idea of how long the item will remain up for auction and may provide further incentive to bid in the auction.

Moreover, the timer may be incremented upon submission of a bid as compared to a non-variable time limit initiated when the auction begins. In this embodiment, although an initial time limit may be set, each individual bid may increase the time left until the end of the auction. The time increment may be absolute such as five minutes for each bid or may be variable based on other factors including bid intensity, time remaining, the cost of the item, the number of bidders in the auction, the pattern of bidding from different bidders, the current difference in cost of the total bids and cost of the item, and/or other qualifiers determined by individual user histories and profiles. The time increment value may also be random. In another embodiment, each bid may instead reset the timer to a particular time rather than adding time to the current time. Accordingly, the timer reset amount may be fixed or may be variable.

On the other hand, other embodiments may not present a timer at all. In particular, some auctions may not provide any indication of when the auction will end, or may present a timer to certain users and not others depending on a user's qualification status, membership status or participation in the auction. Therefore, all or some users are unaware of how much longer the option to bid on a particular item will be available to them. Consequently, the user is encouraged to bid immediately and continuously because the auction could end at any moment. Furthermore, absent any final seconds in which to “snipe” an auction, a user may have more confidence that their bids will ultimately win the auction.

In another embodiment, the navigation module 145B may cause an auction to end based on an event unrelated to time (e.g., based on the duration of an event external to the auction). These particular auctions may end as a result of a single or any combination of events. For example, an auction for an autographed baseball may continue only during a certain playoff game and the auction would end at the end of the game. Also, an auction may be completely controlled by the seller and would end whenever the seller/auction site desired. Any event may trigger the ending of the auction, whether known to the bidders or not. Therefore, bidders are likewise encouraged to bid early and often.

In another embodiment, users may be stratified into different membership levels depending on, for example, number of bids purchased, bid activity, number of items won, number of items lost, and other considerations. These membership levels may grant a user increased benefits in certain auctions. For example, a bidder in the highest membership level may be able to purchase bids at lower cost or to purchase bids with higher bid values as the same cost of bids with normal bid values. Being able to place a bid that results in the application of a higher-than-other increment amount to the current bid value in an auction may price out other bidders more quickly than the alternative. Also, higher membership levels may increase any discount offered on items which were not won in an auction. Membership status and level may be presented to a user by displaying an indication of such on the navigation interface.

Log Module 145C

Log module 145C may be configured to collect some or all information (e.g., messages, bids, personal information of users, selections of options by users) generated at, sent to, and/or received by any of the platforms 110, 120 and 140. The log module 145C may be further configured to cause the database 143 to store the information, and may also be configured to cause the display of information at the bidder platform 110 and the seller platform 120. Such information stored in the database 143 may include but is not limited to date and time, user identification information, remaining bids for a user, total number of bids by a user, number of bids by user on a particular auction, number of bids on related auctions (e.g., auctions for similar items), and total bids by all bidders. The log module 145C may be designed to display the information to the user of the bidder platform 110 and the seller platform 120 in any understandable format, such as a statistic or list, and may be easily sorted or filtered by information such as type of auction, auction date, or by winning and losing auctions. The log module 145C may also include a feature to automatically and continually refresh the log with any recent activity not already displayed to the user. The log module 145C may also feature an export feature to allow a user to print the current report to a file on the platforms 110-140 or to an attached printer.

In particular, the log module tracks all transactions performed on the auction system 100. By tracking each user and their bids and purchases, the log module 145C may accumulate a large database of information that may be used by the control platform 140, for instance, to determine whether a bidder is qualified, whether to promote auctions to certain users, etc. Furthermore, the log module's 145C vast databank may be utilized to help track and distribute any profit shared by a number of subsequent sellers of a certain item. As such, the log module 145C may be important for providing the necessary information to make qualification determinations and tracking the activity and results of individual auctions and bidders.

Bid Purchase Module 145D

The bid purchase module 145D may be configured to manage the purchase and distribution of bids associated with the auction system 100. Generally, the bid purchase module 145D generates and causes the display of interactive web page that presents users with bids for purchase, executes bid purchase transactions, and allocates purchased bids to particular users for use in auctions.

Bids permit a user to bid on items in the auction system 100. Since the auction system 100 may be implemented over the Internet, bid purchases similarly may be carried out over the Internet. Payment for bids may be accepted via various monetary transactions, including cash, credit card, checks, money order, web-based services, and many other known methods of payment. One skilled in the art would appreciate a number of known methods for carrying out Internet transactions including processing, security, and tracking. Ideally, to encourage continuous and frequent bidding by users of the auction system 100, the bid purchase module 145D may utilize a quick and efficient, yet secure, method of providing purchase options for large numbers of bids to users. Users may elect to have bids automatically purchased or may be prompted to purchase more bids when their numbers of bids reaches a predetermined threshold.

In one embodiment, the bid purchase module 145D may present a user with packaged bids for purchase to participate in the auction system 100. A bid may cost the user a certain amount (e.g., $0.50 or any amount). The value of the bid, when applied to an auction may be another amount (e.g., $0.01, and less than the cost of the bid). When a bidder applies/submits/makes a bid in relation to an auction, the total number of available bids for that user is reduced. Once depleted, a user may purchase more incremental bids to continue bidding. Therefore, a bidder quickly becomes financially invested in the auctions, driving up activity and excitement.

The cost of each bid, whether grouped in bulk or sold individually, may vary by embodiment, and may depend on a user's membership or qualification status (e.g., qualified users may be allowed to purchase bids at a discounted cost during the auction in which those user are qualified). For example, one embodiment may sell bid increments at a price equal to the value of the representative increment in an auction. Thus, in a penny auction wherein each bid only raises the auction price by a penny, each bid may be purchased for one cent. However, more often the bid increments will be priced much higher than their bid value at auction. The increased price of the bid may help to offset any losses sustained from items selling below cost. In this way, an auction system 100 may achieve a breakeven point for any particular item simply by receiving bids. Furthermore, this breakeven point algorithm may be easily ascertained by a seller eager to earn revenue through bids. In particular, profitability can be ascertained when the price P of item is exceeded by the sum of aggregate cost of all applied bids and the final auction price.

By way of example, a break-even final auction price may be determined in relation to different amounts of bid costs, bid increment values, and costs of items. If item A costs $100, individual bids cost $0.60, and bid increment values amount to $0.01 per bid applied, then the auction for item A must gather 1.67% of the cost of item A in order to break even. At the break-even point, the price of item A is 1.67%×$100=$1.67, which represents 167 bids at $0.01 bid increments. Therefore, in this example, a break-even final auction price may be determined as follows (assuming non-varying bid costs):

COST(item)=COST(bid)*NUMBER(bids to break even), where

NUMBER(bids to break even)=COST(item)/COST(bid), where

NUMBER(bids)=PRICE(item to winning bidder)/VALUE(bid increments), where

PRICE(item in auction needed to break even)=COST(item)*VALUE(bid)/COST(bid)

Assuming the cost of the item is $100, the cost of each bid is $0.60, and the value the bid in terms of incrementing the auction price is $0.01, then the break even price P is calculated as follows:

$100=$0.60*N

N=$100/$0.60

$100/$0.60=P/$0.01

P=$100*$0.01/$0.60=$1.67

As can be readily appreciated, the price of the item at auction will be significantly less than that cost of the item. One of skill in the art will appreciate alternative and more complicated calculations to those above where different bid increments and bids costs are applied, and where different users use different bid increments and costs.

Unfortunately, many bidders may lose significant sums of money in auctions they do not ultimately win. After only a few auction attempts, users may feel cheated or hopeless, and may quit purchasing bids and ultimately abandon the auction system 100 altogether. Therefore, additional features may be implemented to encourage bidding while protecting the bid increment amount invested by a bidder in an auction by offering qualified bidders benefits, even where the bidder did not win the auction.

Qualification Module 145E

Qualification module 145E may be configured to determine whether a bidder qualifies for additional benefits based on the user's actions within the auction system 100. Generally, the qualification module causes analysis on the data stored at the control platform 140, which may result in a determination whether a user qualifies for additional features for particular auctions. Furthermore, the qualification module 145E may cause the display of an indication to a user of whether they are currently considered qualified for a particular auction at a particular time during that auction. The indicator may be displayed on each auction item's page and may be continually updated on the graphic user interface by the qualification module 145E.

Qualification of a user may be accomplished in any number of ways. Whatever method or algorithm is chosen, the qualification module 145E manages and controls the determination of a bidder's qualification status, which may permit the qualified user to enjoy benefits not otherwise available to non-qualified users (e.g., purchasing discounted bids during the auction, having bid increments for applied bids be valued differently than bid increments for other users, and other benefits available after the end of an auction). While in some embodiments, a determination of qualification has no effect until after an auction ends, the qualification module 145E may, however, make determinations continuously throughout an auction to update the user of their status based on constantly changing data. As such, qualification status may change from instant to instant during a particular auction and therefore, the qualification module 145E may make new determinations continuously, such as whenever a new bid is submitted. Additionally, qualification requirements may be stratified to provide different levels of incentives to more active bidders or bidders with higher membership levels. For example, a particular auction may have bronze, silver, and gold qualification requirements; each appropriately providing better benefits to a qualified bidder based on their status. Bidders may also be provided with an estimate on how many bids are needed in order to qualify.

In one embodiment, qualification may be based on activity of a particular bidder in the current auction. For example, a qualification status may be granted to a bidder whose total cost of aggregate bids placed is greater than a percentage of the item's cost (e.g., wholesale or manufacturer's suggested retail price (“MSRP”)). The percentage may be a fixed value or may vary depending on bids placed by other bidders. For example, a bidder whose bids account for 25% of the cost of the item, yet who still did not win the auction, may still qualify for benefits. This percentage may be known to the user or may be withheld.

In another qualification method, a bidder may be qualified when that bidder's number of bids placed exceeds another bidder's bids by a certain amount. For example, a bidder whose bids amount to 100, which is greater than the amount of bids for another bidder or bidders (e.g., 50 bids), yet who still did not win the auction, may still qualify for benefits. In this way, qualification may also be granted if the loser had the greatest total number of bids among all other bidders in the auction.

In yet another qualification method, a bidder may be further or otherwise considered a qualified when the total cost of aggregate bids placed by all bidders is greater than the difference between the current auction price of the item and the cost of the item, or just greater than the cost of the item. As described above, each item may have a breakeven percentage at which the cost of an item has been recouped through costs of applied bids. Once a bidder has bid enough in a particular auction to recoup all or a part of the item's cost, that user may be determined to be qualified for further benefits. In an auction with many bidders with a desire to achieve a qualified status, an item's cost may be obtained many times over.

Additionally, qualification may also be determined by the number of bids by a particular bidder which account for a predetermined percentage of the total bids on the auctioned item. For example, a bidder whose bids account for 40% of all bids placed on an item, yet who still did not win the auction, may still qualify for benefits.

Rewarding bidders who constantly bid incentivizes participation in the auction, and creates other avenues for bidders to gain value from their investment. While the bidding war on the ultimate sale price of an auctioned item may be important, bidders may also focus on trying to achieve qualification, which reward them with benefits as losers.

Qualification may be determined by historical activity of a user. For example, qualification of a bidder may be based on activity of that particular bidder across many or all auctions in which that bidder has participated. A bidder may be qualified if the total bids from a bidder across multiple auctions is greater than some percentage of total bids on each of those auctions. Qualification may be granted where a bidder's total bids across multiple auctions is simply greater than a threshold amount. Moreover, the total bid threshold may have many different levels which, when achieved, allow the user to obtain increasingly better benefits. One of skill in the art will appreciate variations to these qualification methods that are within the scope and spirit of the invention.

Membership of users is also contemplated by the invention. For example, membership may be based on a point (or credit system) acquired, primarily, by the number of applied bids for a user. Any applied bids in a particular auction may be represented as points accumulated in a running total to be displayed to a user. Upon reaching particular milestones, a user may exchange these points for benefits before, during or after particular auctions. These points may or may not be representative of the true value of the bids invested. Thus, a bidder who has invested $100 in bids may receive 100 points or any fraction or multiple thereof for exchange later. Moreover, points may be acquired through any other act such as listing items, giving feedback, and promoting the auction system 100. Membership levels of a particular user may increase or otherwise augment the amount of points obtained for each action (as compared to other users of different membership levels). Membership levels may further control the amount of points needed to access a benefit. Depending on the benefit desired, points may be either limited to individual auctions or may be accumulated from all user activities.

For example, a bidder may choose to use points in exchange for the opportunity to be a seller in an auction. A bidder may expend 100 bids trying to win an item up for auction. Unfortunately, the bidder may be unsuccessful. However, all or a portion of the invested bids may be credited to the user as points. For example, 100 points may be credited to the user for using 100 bids, 100 additional points may be credited for being the first to bid on the item, and another 50 points for being the auction leader for some minimum period of time. In this example, the user acquired 250 points from an auction. Either during the auction or after, the user may redeem the points for various benefits. Examples of benefits a bidder may receive in exchange for points may be auctioning a similar or different item as a seller for a chance to share a profit (e.g., after a listing fee is removed by the auction site), receiving a refund of invested bids in a particular auction, etc. Some benefits may impact the bidding of other auctions such as blocking bids for a particular period of time or setting the countdown to a lower time upon application of a bid placed by the bidder redeeming the points.

One skilled in the art would appreciate the great number of benefits that may be permitted in addition to point values needed to obtain access to them. Having 250 points, the user above may choose to auction a similar item for 225 points, which then results in 225 points being removed from the user's point account. Any unused points may either be maintained or removed from the user's account. Instead of flat point pricing, the benefits may also be obtained through meeting certain point milestones. For example, a user may achieve membership levels—e.g., level one may be achieved at 100-500 points; level two at 500-1000 points; and level three at 1000+ points. Additional points may also be purchased when a user has insufficient points to acquire a desired benefit.

A user's points may additionally be lowered by an amount of points when to adjust for profit that user has made in relation to auctioning/re-auctioning an item and/or the effective discount receive from purchasing a product at the much lower auction price. For example, when a user wins an item, that user's points may be reduced by the difference between the cost/MSRP/etc. of the item and the amount the user spent to obtain the item (e.g., the cost of the bids placed to win the item and/or the final auction price/bid value of the item). The user's points may alternatively be lowered by any profit from auctions, and the user may carry negative point values depending on the profit margins.

Users who have won items or profited from being a seller may alternatively be restricted from benefits for a certain period of time or until some event. Users may also turn some of their profit into points so that the user is encouraged to fund subsequent auctions.

A user's points may also be negatively impacted by the user's behavior. For example, a user's points may be lowered if that user acts as a power bidder. Power bidders generally include bidders who are aggressive bidders. These bidders employ many different strategies to in attempt to control an auction in their favor. In some cases, power bidders will place an amount of bids that have an aggregate cost that matches or exceeds the cost of the item, or power bidders will place a volume of bids on an item that will far exceed the volumes from other bidders. Power bidding activities can be detected, and decisions can be made based on the detection of these activities. For example, once such power bidding activities are detected, the points for the power bidder may be lowered, frozen or removed entirely. By way of another example, other bidders in the auction in which the power bidder is employing power bidding activities may receive additional bids for free, and/or may purchase the additional bids at a discount to use in that auction in order to punish the power bidding activity. The other bidders, and not the power bidder(s), may alternatively be allowed to access other benefits during that auction.

Benefits Module 145F

Benefits module 145F may be configured to display and provide a bidder of the bidder platform 110 a benefit based on the bidder's qualification status. Offering bidders other benefits, aside from winning the item in an auction, may increase incentives for users to participate in an auction. Benefits may be provided to both losers and winners of any auction. Furthermore, the benefits may help to offset any costs to participants in an auction, thereby increasing the likelihood that a user will find hope in losing and use the auction system 100 to bid on an auction item.

In one embodiment, a qualified winner of an auction may be provided with the option to re-auction the item won. For example, the option may either be provided unconditionally to every winner, provided only to qualified winners, or to a winner that bid an amount of bids with having a total cost that is greater than the cost of the item or another amount. By further incentivizing bidders to win auctions, this benefit may increase bid activity as well as the final auction price of the item. Additionally, a bidder who wins an auction at a low price may, in turn, be able to re-auction the item and possibly collect a share in the profit from the re-auction or a share in the re-auction price from the re-auction.

In one embodiment, a qualified winner may share in the profit or auction price for a re-auctioned item with the original seller. If a re-auction of an item sells for a specified amount (e.g., at some percentage of or greater than the original auction price, the cost of item, or some fixed amount, or at or above the difference between the cost and the original auction price or the difference between the original auction price and the cost, among others), then the benefits module 145F may split any profit on the sale or the sale price between the current seller and the original seller (and possibly the auction site). Splits in profits may be determined by a predefined percentage, the amount of bids placed by the winner (or qualified bidder), the amount of bids placed by the winner in relation to other bidders, the cost of bids place by the winner in relation to the profit or the cost of the item, and other factors.

Furthermore, the current seller may be refunded their original bid costs associated with the item to further incentivize “flipping” auction items. Since each auction may have a service fee associated with it paid by the seller to the auction site, any profit to be distributed may be determined either before or after the service fee is applied.

Similarly, profit from any subsequent auction of an item may be shared between the current seller and all previous sellers (or previous sellers that maintain a particular membership status). Thus, not only may winners who re-auction an item collect a profit, but the previous sellers of the item may share in a payout as well on subsequent re-auctions of the item. For example, a winner (i.e., first winner) of an auction for a pair of sneakers may win the item with a bid well below the cost of the sneakers. The winner, believing he/she can make a profit by re-auctioning, may choose to accept a benefit that allows the user to re-auction the sneakers. If, as predicted, the subsequent auction sells for greater than a predetermined amount (e.g., cost of the sneakers, or some other amount), the original winner may split any profit earned with the original seller. Likewise, the subsequent winner (i.e., the second winner) of the subsequent re-auction may also choose to re-auction the item in an attempt to make a profit. Any profit derived from this final auction may be split between the second winner, the first winner, and/or the original seller. Alternatively, the profit may only be shared between the second winner and original seller should the first winner not be qualified to share in the profits (e.g., because the first winner has not obtained a particular membership status). The amount of profit allocated to any user may also depend on that user's membership status. For example, the second winner may obtain 30% of profit as a level one member or 60% as a level three member. The percentage share of profit may be set to encourage previous winners to bid on the same item in subsequent re-auctions to gain an even larger share of profit by benefiting from two shares of profit that collectively are larger than one share of profit.

Profit may indefinitely be shared in any of the above ways until the auctioned item is either shipped to a winner or fails to sell for a profit. Profit sharing percentages may be predetermined by the auction system 100 or agreed to by the original seller and subsequent winners. As an example, an original seller may receive 20% of any profit obtained through a re-auction of their product. Upon a second profitable sale, the original seller may split the 20% with the first winner (e.g., 10% for original seller and 10% for first winner or 5% for original seller and 15% for first winner). Each subsequent sale, therefore, increases the profit sharing between each subsequent seller.

The invention may also provide benefits to qualified losers of an auction. Providing the losers with other options may increase the overall bid intensity by ensuring that certain bidders who do not win a particular auction may still access benefits. For instance, a qualified loser may be presented with the option of purchasing an item similar to the auctioned item at a discounted price. The discount may be any discount such as a flat discount or a percentage discount. The discount may also be related to the amount of money, through cost of applied bids, the qualified loser has invested in the auction. By providing benefits to qualified losers, the auction system 100 greatly incentivizes bidding because bidders other than the auction winner may benefit from an auction.

Furthermore, the qualified loser may also be given the opportunity to auction the similar item that was purchased at a discount in a similar manner to that described above in relation to a qualified winner. The discounted price may be even further discounted if a qualified loser chooses this option. The discounted price may depend on, for example, the profit from the original auction. For example, if the profit was $200 in the original auction, a qualified loser may be allowed to auction a similar item as a seller by paying a purchase amount equal to the cost of the item less the cost of the bids placed by the qualified loser in the original auction and/or a percentage of the profit realized in the original auction.

The above purchase amount may be refundable to the qualified user should auction of the similar item fail to meet or exceed a break even auction price. If the item subsequently sells for a profit, the qualified loser may also split the profits with the original seller and may have any bid increments invested refunded. The profit sharing determinations would be similar to those described for an auction winner that chooses to re-auction the won item. Similar to the qualified winner, any subsequent profits from the purchased item may also be shared with all the previous sellers of the item from the original auction. As previously described, appropriate fees and service charges may apply to auctions of items by sellers.

Access to benefits may be permitted in exchange for points acquired by users based on actions in the auction system 100. As described above, these actions may include bidding, selling, advertising, or many other situations where a user participates in the system 100. Such benefits may be exchanged for particular point values, such as 100 points to relist a won item or list an item that was similar to a lost item.

As previously mentioned, some benefits may be used during auctions. In particular, a user may be awarded with privileges which may impact an auction such as affecting the bid price, auction structure, or subsequent bidders in order to gain an advantage. Certain auctions may incorporate a game into auctioning wherein the participants may compete against each other by using not only bids but benefits acquired by completing specified actions on the site. Some benefits that may affect an auction include resetting or decrementing auction time after a bid is placed, preventing any bids for a period of time, immediately stopping the auction after a quick countdown, and also benefits which could operate to nullify the effects of these detrimental benefits. One skilled in the art would appreciate the large number of actions and parameters which may be affected. Overall, such game structure may help to continually encourage the purchase of bid increments all the while providing users with satisfying and exciting interactivity with an auction system 100.

Aspects described herein apply to penny auctions, eBay-style auctions, Amazon-style marketplaces and other online methods and systems for conducting commerce. In an Amazon-style marketplace, users could pay for a number of bids equal to the market price of a product, and then attempt to outbid other users in an auction in order to purchase the product for less than its market price. If a user cannot win the auction, that user still receives the product because the user purchased the number of bids equal to the market price.

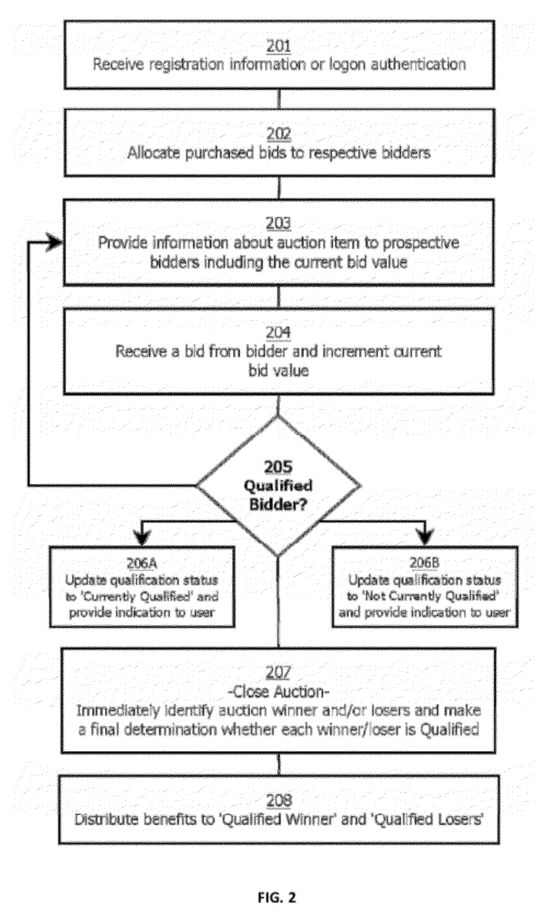

FIG. 2 represents a process by which the control platform 140 may receive a bid from a user. First, at step 201 the user inputs their login information. If the user has not previously used the auction system 100, they may register as a new user. At step 202 the user purchases bids from the bid purchase module 145D and is credited with those bids. Step 203 involves the user navigating through the auction system 100 and being presented with information on each auction. At step 204, the bidder places a bid on an item using the bidder platform 110 which is received by the control platform 140. The current bid value is then incremented. After each bid, at Step 205, every bidder's qualification status is rechecked in accordance with the recently received bid. If the user is qualified, Step 206A updates the qualification status to ‘Currently Qualified’ and indicates this to the user. However, if the user remains unqualified, at Step 206B the control platform 140 updates the status as such and provides an indication. Steps 203-206 repeat until, at Step 207, the auction ends. As described above many different events may cause the ending of an auction. But at the end of each auction the control platform 140 immediately identifies the auction winner and the other losers. Finally, the system makes a last determination of whether each bidder is qualified. At Step 208, the control platform 140 distributes benefits to the qualified winner and qualified losers as described herein.

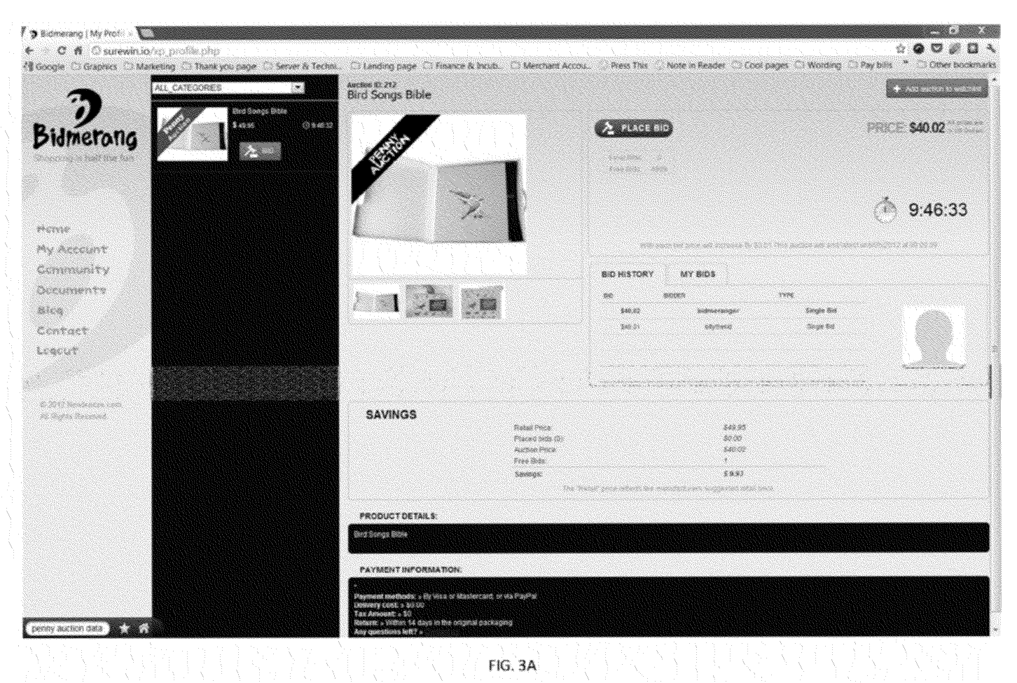

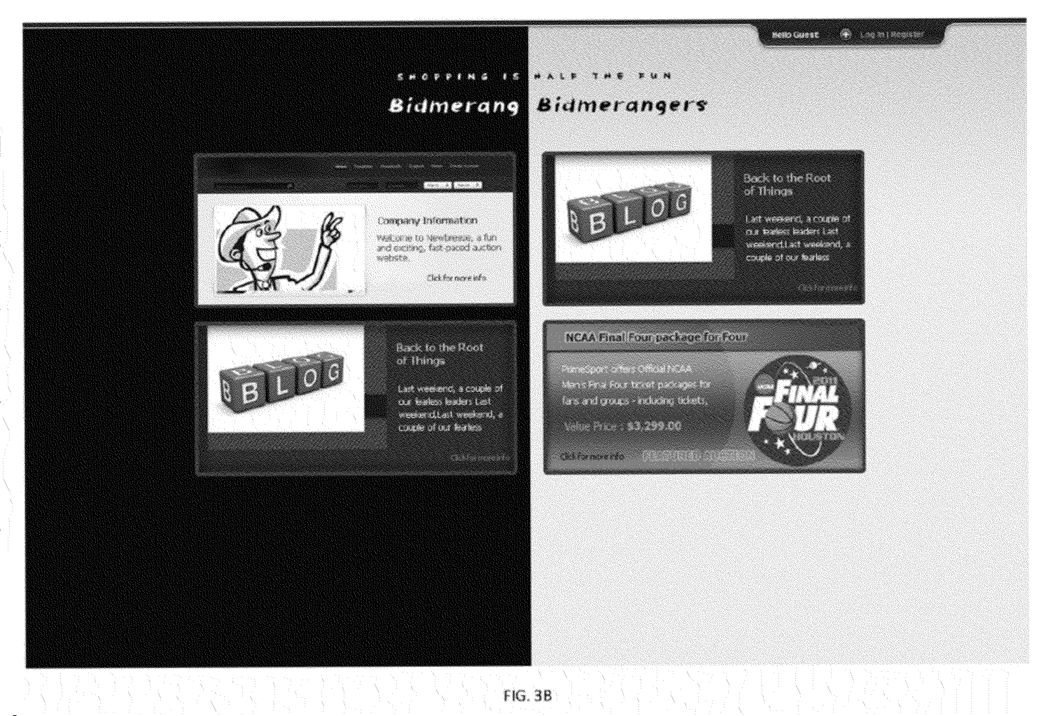

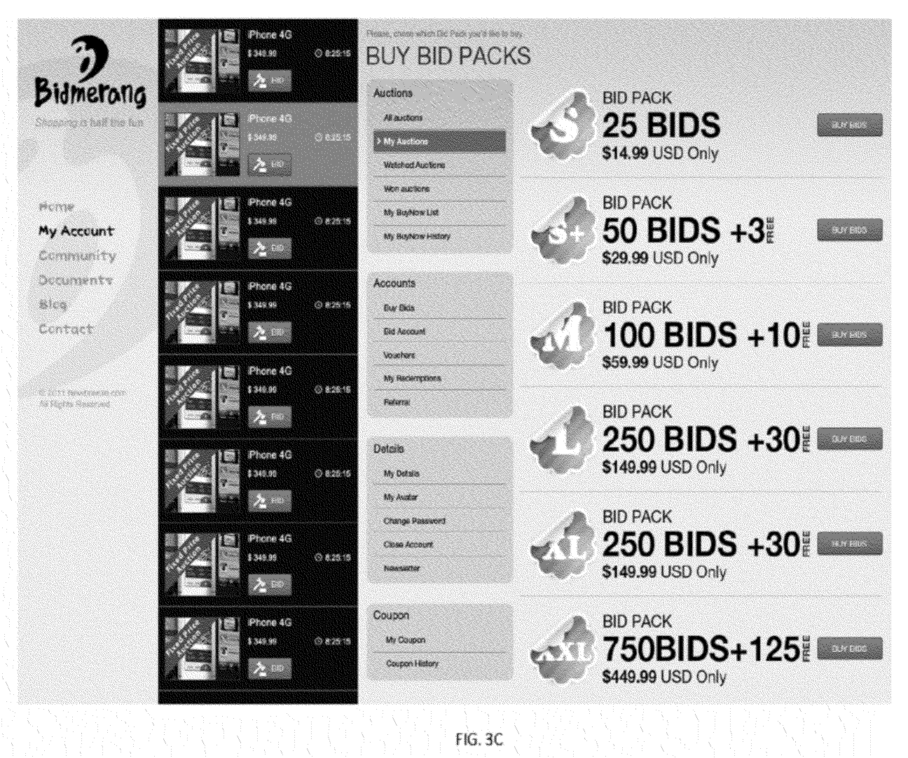

FIGS. 3A-C depict user interfaces.

With respect to the above, it is to be understood that the systems and methods described herein are not limited in their application to the details of construction and to the arrangement of the components or the steps set forth in the previous description. As such, those skilled in the art will appreciate that the auction system 100 described above and its various components may be rearranged and adapted for different embodiments for carrying out the several purposes of the invention.

The invention provides for various aspects. For example, one aspect relates to providing a system and method for facilitating the sale of goods and services through an auction, and for providing a method and system to offer bidders the potential for purchasing goods and services at huge discounts from retail pricing. Other aspects of the invention provide bidders compelling reasons for purchasing goods by providing the infrastructure to enable winning bidders to optionally make a potential profit on goods or services they have purchased at substantial savings by re-auctioning the items, and providing losing bidders with the potential to become qualified to participate in prospective profits from subsequent auctions for products similar to the items they did not win.

Some aspects of the invention relate to providing users an option to sell items instead of auctioning those items (e.g., for a winner to sell the won item as opposed to relisting for subsequent auction). For example, in accordance with one aspect a virtual store may be provided so users can sell items to other users.

Other aspects of the invention relate to exchanging an item (e.g., a won item) from a user (e.g., a winner of that item) for some monetary amount and/or benefits for that user (e.g., bid credits).

It is understood that the specific order components disclosed herein are examples of exemplary approaches. Based upon design preferences, it is understood that the specific order components may be rearranged, and/or components may be omitted, while remaining within the scope of the present disclosure unless noted otherwise. The previous description of the disclosed embodiments is provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The disclosure is not intended to be limited to the aspects shown herein, but is to be accorded the full scope consistent with the specification and drawings, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In accordance with certain aspects of the present invention, one or more of the process steps described herein may be stored in memory as computer program instructions. These instructions may be executed by a digital signal processor, an analog signal processor, and/or another processor, to perform the methods described herein. Further, the processor(s), the memory, the instructions stored therein, or a combination thereof may serve as a means for performing one or more of the method steps described herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Any processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments may be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. It is intended that the following claims and their equivalents define the scope of the invention.

Aspects of the present invention are typically carried out in or resident on a computing network. The computing network generally includes computer hardware components such as servers, monitors, I/O devices, network connection devices, as well as other associated hardware. In addition, the aspects and features described below may include one or more application programs configured to receive, convert, process, store, retrieve, transfer and/or export data and other content and information. As an example, these aspects and features may include one or more processors that may be coupled to a memory space comprising SRAM, DRAM, Flash and/or other physical memory devices. Memory space may be configured to store an operating system (OS), one or more application programs, such as a UI program, data associated with the pertinent aspect or feature, applications running on processors in the device, user information, or other data or content. The various aspects and features of the present invention may further include one or more User I/O interfaces, such as keypads, touch screen inputs, mice, Bluetooth devices or other I/O devices. In addition, the certain aspects and features may include a cellular or other over the air wireless carrier interface, as well as a network interface that may be configured to communicate via a LAN or wireless LAN (WiLAN), such as a Wi-Fi network. Other interfaces, such as USB or other wired interfaces may also be included.

As used herein, computer program products comprising computer-readable media including all forms of computer-readable medium except, to the extent that such media is deemed to be non-statutory, transitory propagating signals.

While various embodiments of the present invention have been described in detail, it may be apparent to those skilled in the art that the present invention can be embodied in various other forms not specifically described herein. Therefore, the protection afforded the present invention should only be limited in accordance with the following claims.

What is claimed is:

1. A system for auctioning one or more items to one or more bidders, the system comprising a processor in communication with the one or more client devices over a network, said processor operable to:
store, for two or more bidders, a number of available bids associated with each of the two or more bidders;
provide, during a first adjustable time period, a first current bid value associated with a first item;
during the first adjustable time period, receive a first plurality of successive bids from a first plurality of bidders;
for each of the first plurality of successive bids, increment the first current bid value of the first item by a predetermined amount; and
determine whether each respective bidder from the first plurality of bidders is a qualified bidder.

2. The system of claim 1, said processor further operable to:
during the first adjustable time period, determine a respective aggregate number of bids from the first plurality of successive bids attributable to each of the first plurality of bidders;
based on the respective aggregate number of bids for each of the first plurality of bidders, determine whether each of the respective bidders is the qualified bidder;
determine that a first bidder of the first plurality of bidders is a qualified bidder when the first current bid value is greater than a cost of the first item; and
send, for display at a remote computing device operated by each qualified bidder, an indication that the respective qualified bidder is qualified at the time the indication was sent.

3. The system of claim 2, said processor further operable to:
determine that the first bidder of the first plurality of bidders is a qualified bidder when a first aggregate number of bids for the first bidder is greater than a predetermined percentage of the cost of the first item, or a first aggregate number of bids for the first bidder is greater than a difference between the first current bid value and the cost of the first item.

4. The system of claim 2, said processor further operable to:
determine that the first bidder of the first plurality of bidders is a qualified bidder when a first aggregate number of bids for the first bidder is greater than a predetermined percentage of the first current bid value.

5. The system of claim 2, said processor further operable to:
determine that the first bidder of the first plurality of bidders is a qualified bidder when a first aggregate number of bids for the first bidder is greater than each of the first aggregate number of bids for each remaining bidder of the first plurality of bidders.

6. The system of claim 1, said processor further operable to:
during the first adjustable time period, determine a respective aggregate number of bids from the first plurality of successive bids attributable to each of the first plurality of bidders;
based on the respective aggregate number of bids for each of the first plurality of bidders, determine whether each of the respective bidders is the qualified bidder;
determine that a first bidder of the first plurality of bidders is a qualified bidder when a first total number of bids for the first bidder associated with the first item and one or more other items is greater than a predetermined percentage of a sum of the first current bid value of the first item and respective bid values of the one or more other items; and
send, for display at a remote computing device operated by each qualified bidder, an indication that the respective qualified bidder is qualified at the time the indication was sent.

7. The system of claim 1, said processor further operable to:
during the first adjustable time period, determine a respective aggregate number of bids from the first plurality of successive bids attributable to each of the first plurality of bidders;
based on the respective aggregate number of bids for each of the first plurality of bidders, determine whether each of the respective bidders is the qualified bidder;
determine that a first bidder of the first plurality of bidders is a qualified bidder when a first total number of bids for the first bidder associated with the first item and one or more other auction items is greater than a first threshold number of bids; and
send, for display at a remote computing device operated by each qualified bidder, an indication that the respective qualified bidder is qualified at the time the indication was sent.

8. The system of claim 1, said processor further operable to:
upon cessation of the first adjustable time period, identify a first winning bidder associated with a last bid of the first plurality of successive bids and identify the first current bid value;
receive, from the first winning bidder, a request to re-auction the first item;
provide, during a second adjustable time period, a second current bid value associated with the first item;
during the second adjustable time period, receive a second plurality of successive bids from a second plurality of bidders;
for each of the second plurality of successive bids, increment the second current bid value of the first item by a predetermined amount;
upon cessation of the second adjustable time period, identify a second winning bidder associated with a last bid of the second plurality of successive bids;
provide a fractional portion of the second current bid value to the first winning bidder when the second current bid value exceeds a predetermined current bid value.

9. The system of claim 8, wherein the predetermined current bid value equals the difference between the cost of the first item and the first current bid value.

10. The system of claim 1, said processor further operable to:
upon cessation of the first adjustable time period, determine a second aggregate number of bids from the first plurality of successive bids attributable to a first qualified bidder;
receive, from the first qualified bidder, a request to auction a second item that is substantially similar to the first item;
receive, from the first qualified bidder, a payment equal to the difference between a cost or suggested list price of the second item and the second aggregate number of bids from the first plurality of successive bids;
provide, during a third adjustable time period, a third current bid value associated with the second item;
during the third adjustable time period, receive a third plurality of successive bids from a third plurality of bidders;
for each of the third plurality of successive bids, increment the third current bid value of the first item by a predetermined amount;
upon cessation of the third adjustable time period, identify a third winning bidder associated with a last bid of the third plurality of successive bids;
determine whether the third current bid value is greater than the cost of the second item;
upon determining that the third current bid value is greater than the cost of the second item, provide a fractional portion of the third current bid value to the first qualified bidder; and
upon determining that the third current bid value is less than the cost of the second item, refund the payment to the first qualified bidder.

11. The system of claim 10, said processor further operable to:
upon determining that the third current bid value is greater than the cost of the second item, determine whether the difference between the third current bid value and the cost of the second item is greater than the first aggregate number of bids for the first bidder; and
upon determining that the difference between the third current bid value and the cost of the second item is greater than the first aggregate number of bids for the first bidder, refund the first aggregate number of bids to the first qualified bidder.

12. The system of claim 8, said processor further operable to:
receive, from the second winning bidder, a request to re-auction the first item;
provide, during a fourth adjustable time period, a fourth current bid value associated with the first item;
during the fourth adjustable time period, receive a fourth plurality of successive bids from a fourth plurality of bidders;
for each of the fourth plurality of successive bids, increment the fourth current bid value of the first item by a predetermined amount;
upon cessation of the fourth adjustable time period, identify a third winning bidder associated with a last bid of the fourth plurality of successive bids; and
provide a fractional portion of the fourth current bid value to the first winning bidder and the second winning bidder when the fourth current bid value exceeds a the cost of the first item.

13. A computer-implemented method for auctioning one or more items to one or more bidders, the computer-implemented method comprising:
storing, for two or more bidders, a number of available bids associated with each of the two or more bidders;
providing, during a first adjustable time period, a first current bid value associated with a first item;
during the first adjustable time period, receiving a first plurality of successive bids from a first plurality of bidders;
for each of the first plurality of successive bids, incrementing the first current bid value of the first item by a predetermined amount; and
determining whether each respective bidder from the first plurality of bidders is a qualified bidder.

14. The computer-implemented method of claim 13, the method further comprising:
during the first adjustable time period, determining a respective aggregate number of bids from the first plurality of successive bids attributable to each of the first plurality of bidders;
based on the respective aggregate number of bids for each of the first plurality of bidders, determining whether each of the respective bidders is the qualified bidder;
upon cessation of the first adjustable time period, identifying a first winning bidder associated with a last bid of the first plurality of successive bids and identify the first current bid value;
receiving, from the first winning bidder, a request to re-auction the first item;
providing, during a second adjustable time period, a second current bid value associated with the first item;
during the second adjustable time period, receiving a second plurality of successive bids from a second plurality of bidders;
for each of the second plurality of successive bids, incrementing the second current bid value of the first item by a predetermined amount;
upon cessation of the second adjustable time period, identifying a second winning bidder associated with a last bid of the second plurality of successive bids; and
providing a fractional portion of the second current bid value to the first winning bidder when the second current bid value exceeds a predetermined current bid value.

15. The computer-implemented method of claim 13, the method further comprising:
at a first instance in time during the first adjustable time period, determining a first respective aggregate number of bids from the first plurality of successive bids attributable to each of the first plurality of bidders;
based on the first respective aggregate number of bids for each of the first plurality of bidders, determining whether each of the respective bidders is qualified at the first instance in time;
determining that a first bidder of the first plurality of bidders is qualified at the first instance in time;
sending, for display at a remote computing device operated by each qualified bidder during the first adjustable time period, an indication that the respective qualified bidder is qualified as of the first instance in time;
at a second instance in time during the first adjustable time period, determining a second respective aggregate number of bids from the first plurality of successive bids attributable to each of the first plurality of bidders;
based on the second respective aggregate number of bids for each of the first plurality of bidders, determining whether each of the respective bidders is qualified at the second instance in time;
determining that the first bidder of the first plurality of bidders is not qualified at the second instance in time;
upon cessation of the first adjustable time period, determining whether the first qualified bidder is qualified;
upon determining that the first bidder is qualified upon cessation of the first adjustable time period, receiving, from the first qualified bidder, a request to auction a second item that is substantially similar to the first item;
receiving, from the first qualified bidder, a payment equal to the difference between a cost or suggested list price of the second item and the second aggregate number of bids from the first plurality of successive bids;
providing, during a third adjustable time period, a third current bid value associated with the second item;
during the third adjustable time period, receiving a third plurality of successive bids from a third plurality of bidders;
for each of the third plurality of successive bids, incrementing the third current bid value of the first item by a predetermined amount;
upon cessation of the third adjustable time period, identifying a third winning bidder associated with a last bid of the third plurality of successive bids;
determining whether the third current bid value is greater than the cost of the second item;
upon determining that the third current bid value is greater than the cost of the second item, providing a fractional portion of the third current bid value to the first qualified bidder; and
upon determining that the third current bid value is less than the cost of the second item, refunding the payment to the first qualified bidder;
upon determining that the third current bid value is greater than the cost of the second item, determining whether the difference between the third current bid value and the cost of the second item is greater than the first aggregate number of bids for the first bidder; and
upon determining that the difference between the third current bid value and the cost of the second item is greater than the first aggregate number of bids for the first bidder, refunding the first aggregate number of bids to the first qualified bidder.

16. A computer program product comprising a computer usable medium having a computer readable program code embodied therein, said computer readable program code adapted to be executed to implement a method for auctioning one or more items to one or more bidders, the method comprising:
storing, for two or more bidders, a number of available bids associated with each of the two or more bidders;
providing, during a first adjustable time period, a first current bid value associated with a first item;
during the first adjustable time period, receiving a first plurality of successive bids from a first plurality of bidders;
for each of the first plurality of successive bids, incrementing the first current bid value of the first item by a predetermined amount; and
determining whether each respective bidder from the first plurality of bidders is a qualified bidder.

17. The computer program product of claim 16, the method further comprising:
during the first adjustable time period, determining a respective aggregate number of bids from the first plurality of successive bids attributable to each of the first plurality of bidders;
based on the respective aggregate number of bids for each of the first plurality of bidders, determining whether each of the respective bidders is the qualified bidder;
upon cessation of the first adjustable time period, identifying a first winning bidder associated with a last bid of the first plurality of successive bids and identify the first current bid value;
receiving, from the first winning bidder, a request to re-auction the first item;
providing, during a second adjustable time period, a second current bid value associated with the first item;
during the second adjustable time period, receiving a second plurality of successive bids from a second plurality of bidders;
for each of the second plurality of successive bids, incrementing the second current bid value of the first item by a predetermined amount;
upon cessation of the second adjustable time period, identifying a second winning bidder associated with a last bid of the second plurality of successive bids;
providing a fractional portion of the second current bid value to the first winning bidder when the second current bid value exceeds a predetermined current bid value.;
at a first instance in time during the first adjustable time period, determining a first respective aggregate number of bids from the first plurality of successive bids attributable to each of the first plurality of bidders;
based on the first respective aggregate number of bids for each of the first plurality of bidders, determining whether each of the respective bidders is qualified at the first instance in time;
determining that a first bidder of the first plurality of bidders is qualified at the first instance in time;
sending, for display at a remote computing device operated by each qualified bidder during the first adjustable time period, an indication that the respective qualified bidder is qualified as of the first instance in time;
at a second instance in time during the first adjustable time period, determining a second respective aggregate number of bids from the first plurality of successive bids attributable to each of the first plurality of bidders;
based on the second respective aggregate number of bids for each of the first plurality of bidders, determining whether each of the respective bidders is qualified at the second instance in time;
determining that the first bidder of the first plurality of bidders is not qualified at the second instance in time;
upon cessation of the first adjustable time period, determining whether the first qualified bidder is qualified;
upon determining that the first bidder is qualified upon cessation of the first adjustable time period, receiving, from the first qualified bidder, a request to auction a second item that is substantially similar to the first item;
receiving, from the first qualified bidder, a payment equal to the difference between a cost or suggested list price of the second item and the second aggregate number of bids from the first plurality of successive bids;
providing, during a third adjustable time period, a third current bid value associated with the second item;
during the third adjustable time period, receiving a third plurality of successive bids from a third plurality of bidders;
for each of the third plurality of successive bids, incrementing the third current bid value of the first item by a predetermined amount;
upon cessation of the third adjustable time period, identifying a third winning bidder associated with a last bid of the third plurality of successive bids;
determining whether the third current bid value is greater than the cost of the second item;
upon determining that the third current bid value is greater than the cost of the second item, providing a fractional portion of the third current bid value to the first qualified bidder; and
upon determining that the third current bid value is less than the cost of the second item, refunding the payment to the first qualified bidder;
upon determining that the third current bid value is greater than the cost of the second item, determining whether the difference between the third current bid value and the cost of the second item is greater than the first aggregate number of bids for the first bidder; and
upon determining that the difference between the third current bid value and the cost of the second item is greater than the first aggregate number of bids for the first bidder, refunding the first aggregate number of bids to the first qualified bidder.
